(19) United States
(12) Patent Application Publication
(10) Pub. No.: US 2024/0351191 A1
(43) Pub. Date: Oct. 24, 2024

(54) EXOSKELETON DEVICE AND METHOD

(71) Applicant: FESTOOL GMBH, Wendlingen (DE)

(72) Inventors: Bernward OTTEN, Hamburg (DE); Robert WEIDNER, Bohlsen (DE)

(21) Appl. No.: 18/682,823

(22) PCT Filed: Aug. 12, 2022
(86) PCT No.: PCT/EP2022/072713

§ 371 Date: Feb. 9, 2024

(30) Foreign Application Priority Data
Aug. 13, 2021 (DE) 10 2021 208 910.0

(51) Int. Cl. B25J 9/00

(52) U.S. Cl. CPC B25J 9/0006

(57) ABSTRACT

An exoskeleton device including an exoskeleton with a base section for attachment to a body section, in particular the torso, of the human body, a support section movably coupled to the base section for supporting a body part, preferably a limb, in particular an arm, of the human body, an actuator device, in particular a pneumatic actuator device, acting on the support section for providing a support force for the body part. The exoskeleton device further includes a light output device and a control device which is configured to control the light output device in order to adjust an orientation of a light beam provided by the light output device and/or a light intensity of the light output device and/or to project auxiliary information into an environment of the exoskeleton device.

The invention relates to an exoskeleton device comprising an exoskeleton with a base section for attachment to a body section, in particular the torso, of the human body, a support section movably coupled to the base section for supporting a body part, preferably a limb, in particular an arm, of the human body, and an actuator device, in particular a pneumatic actuator device, acting on the support section for providing a support force for the body part.

An exoskeleton is a device worn on the body that supports the musculoskeletal system in certain postures and movements.

It is an object of the invention to provide an exoskeleton device that enables the user to work more easily and/or more safely and/or with higher quality.

The object is solved by an exoskeleton device according to claim 1. The exoskeleton device comprises a light output device and a control device which is configured to control the light output device in order to adjust an orientation of a light beam provided by the light output device and/or a light intensity of the light output device and/or to project auxiliary information into an environment of the exoskeleton device.

Preferably, the light output device comprises a light source that is integrated into the exoskeleton. The light output device can make work easier and/or safer for the user, as this eliminates or can eliminate the need to handle external light sources, for example.

Advantageous further developments are the subject of the dependent claims.

Preferably, the light source can be powered by a rechargeable battery in the exoskeleton so that no external power supply is required during operation. This is particularly advantageous on construction sites.

The control device can expediently adjust the orientation of the light source automatically. In this way, it is possible to avoid the user having to carry out manual readjustment, for example on external lamps.

Compared to conventional floor lamps, the advantage can be attained that shadows cast by the user are reduced and/or the user does not need to manually move the lamp when changing location.

Expediently, the light output device is not arranged on a helmet or on the user's head. Compared to a lamp arranged on the helmet or on the user's head, a light source arranged on the exoskeleton can offer the advantage that fewer movements have to be compensated for, for example, in order to illuminate an object in a stable manner or to project a reference line and/or a reference point onto a workpiece or a surface to be processed in a stable manner.

Preferably, the exoskeleton device can provide an augmented reality function by means of the light source, in particular the light output device, so that the user preferably has the advantage of not having to wear augmented reality glasses, which would otherwise be used to implement similar functions.

Optionally, the exoskeleton device provides a “pick-by-light” function. For example, a pick-by-light system is integrated into the exoskeleton, in particular for picking in a warehouse. In particular, this eliminates the need to equip storage boxes and compartments with lights and associated electronics. With this variant, maintenance work is limited to the exoskeleton.

The invention further relates to a method according to claim 17.

Further exemplary details and exemplary embodiments are explained below with reference to the figures. Thereby shows

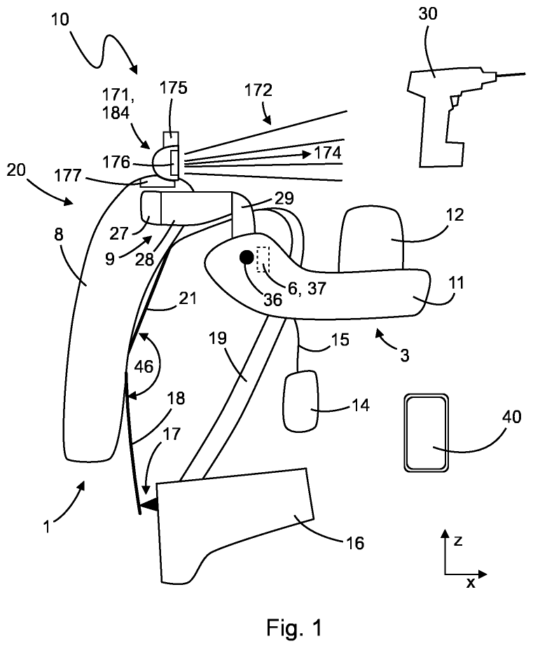

FIG. 1 a schematic side view of an exoskeleton device,

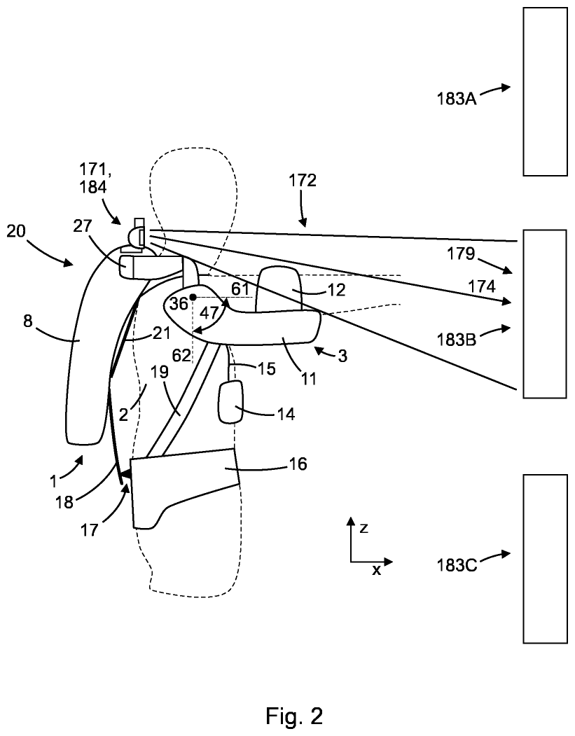

FIG. 2 a schematic side view of an exoskeleton worn by a user,

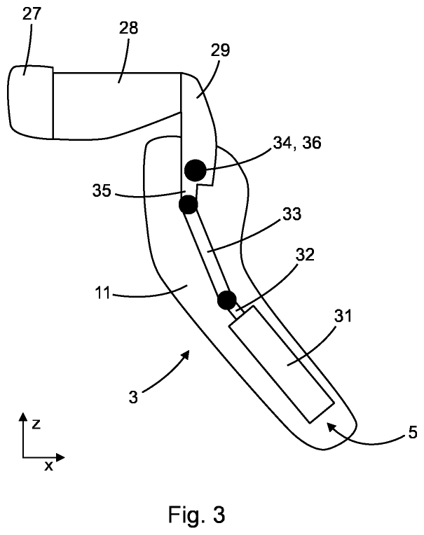

FIG. 3 a schematic detailed view of a support section of the exoskeleton,

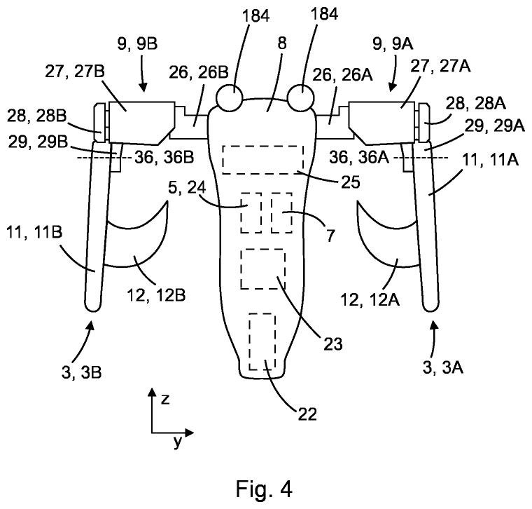

FIG. 4 a schematic rear view of the exoskeleton,

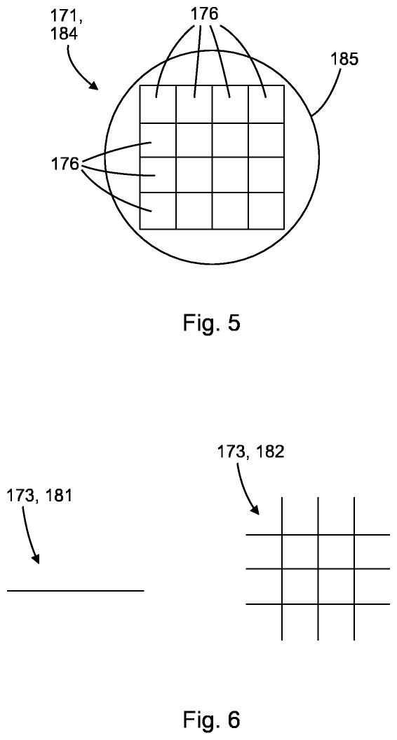

FIG. 5 a light output device with several light output sections,

FIG. 6 auxiliary information with an auxiliary line and a grid, and

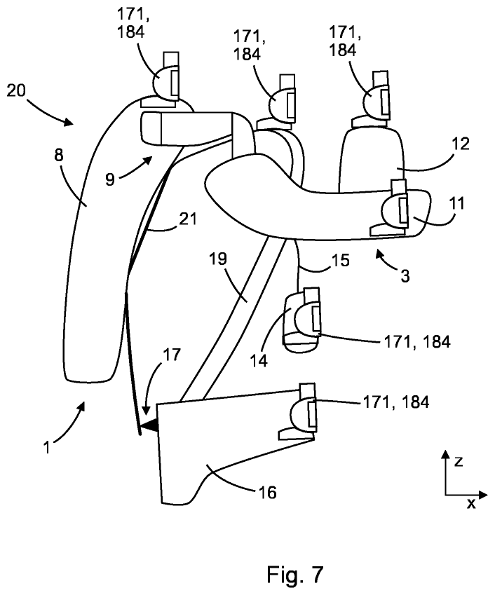

FIG. 7 an exoskeleton with light output units mounted at various positions.

In the following explanations, reference is made to the spatial directions x-direction, y-direction and z-direction, which are drawn in the figures and are aligned orthogonally to each other. The z-direction can also be referred to as the vertical direction, the x-direction as the depth direction and the y-direction as the width direction.

FIG. 1 shows a schematic representation of an exoskeleton device 10 comprising an exoskeleton 20 and optionally a tool 30 and/or a mobile device 40. The exoskeleton 20 can also be provided on its own. The tool 30 and/or the mobile device 40 are exemplarily provided separately from the exoskeleton 20, i.e. in particular not mechanically connected to the exoskeleton 20. The tool 30 is, for example, a power tool, in particular a cordless screwdriver and/or a drill and/or a grinder. The mobile device 40 is preferably a smartphone or a tablet. Optionally, the exoskeleton 20 is configured to communicate with the tool 30 and/or the mobile device 40, in particular wirelessly.

As an example, the exoskeleton 20 is aligned in an upright orientation with its vertical axis (which in particular runs parallel to a base section axis 62) parallel to the z-direction. In particular, the exoskeleton 20 is aligned in the upright orientation with its sagittal axis parallel to the x-direction. In a state in which the user has put on the exoskeleton 20, the sagittal axis of the exoskeleton 20 runs parallel to the sagittal axis of the user, i.e. in particular parallel to a direction from the rear—i.e. in particular the back of the user—to the front—i.e. in particular the chest of the user. The horizontal axis of the exoskeleton 20 runs in particular in the width direction of the exoskeleton 20 and/or parallel to the y-direction. In a state in which the user has put on the exoskeleton 20, the horizontal axis of the exoskeleton 20 runs parallel to the horizontal axis of the user, i.e. in particular parallel to a direction from a first shoulder of the user to a second shoulder of the user. The vertical axis of the exoskeleton 20, the sagittal axis of the exoskeleton 20 and the horizontal axis of the exoskeleton 20 are aligned orthogonally to each other.

The exoskeleton device 10 is designed in particular for manual and/or industrial use. Preferably, the exoskeleton device 10 is not designed for medical and/or therapeutic use.

The exoskeleton 20 is an active exoskeleton and in particular has an internal energy source from which the energy for the support force is provided. In particular, the exoskeleton 20 is an active exoskeleton for actively supporting the user's shoulder joint.

The exoskeleton 20 comprises a base section 1 for attachment to a body section of a human body of a user. By way of example, the base section 1 serves to be attached to the torso 2 of the human body.

The base section 1 comprises a main section and a textile carrying system, which is in particular detachably attached to the main section. By way of example, the main section serves to be worn on the back of the human body by means of the textile carrying system, in particular in a backpack-like manner. The main section comprises a back part 8, which is in particular elongated and which is expediently aligned with its longitudinal axis vertically and/or in the longitudinal direction of the user's back. For example, the longitudinal direction of the back part 8 extends along the longitudinal direction of the back. The main section further comprises a force transmission element 18, which is in particular strip-shaped and/or rigid and extends downwards from the back part 8 to a pelvic strap 16 in order to mechanically couple the back part 8 to the pelvic strap 16. The force transmission element 18 is expediently used to transmit a reaction force, which is transmitted from a support section 3 to the back part 8, further to the pelvic strap 16. As an example, the back part 8 is tubular and/or backpack-shaped. The back part 8 is in particular rigid. In particular, the back part 8 comprises an expediently rigid back part housing, which is made, for example, from an in particular rigid plastic and/or as a hard shell. The back part 8 expediently serves to transmit a force from the support section 3 to the force transmission element 18 and/or to accommodate components for controlling the support force.

The support section 3 can expediently be referred to as an arm actuator.

The force transmission element 18 is exemplarily sword-shaped and can also be referred to as a sword. Expediently, the force transmission element 18 is designed to be adjustable relative to the back part 8, in particular in order to change the vertical extent of the main section and/or a force transmission element angle 46 between the force transmission element 18 and the back part 8 facing the user's back. Expediently, the force transmission element 18 is mounted for translational and/or rotational movement relative to the back part 8 and, in particular, can be moved into various translational and/or rotational positions relative to the back part 8 and, in particular, can be locked. The translational movement is in particular vertical. The rotational movement is expediently performed about an adjustment axis aligned parallel to the y-direction.

The textile carrying system comprises, by way of example, the pelvic strap 16 and/or at least one, preferably two, shoulder straps 19. The pelvic strap 16 expediently forms a loop so that, when worn, it surrounds the torso 2, in particular the hips, of the user. Each shoulder strap 19 extends exemplarily from the main section, in particular from the back part 8, to the pelvic strap 16, expediently over a respective shoulder of the user when the exoskeleton 20 is worn.

The exoskeleton 20 further comprises, by way of example, a force transmission element joint 17, via which the force transmission element 18 is attached to the pelvic strap 16. The force transmission element joint 17 is designed, for example, as a ball joint and can be referred to as a sacral joint. When the exoskeleton 20 is worn, the force transmission element joint 17 is arranged in the lower back region of the user, in particular centered in the width direction.

By way of example, the textile carrying system also comprises a back net 21, which is arranged on the side of the back part 8 facing the user's back. When the exoskeleton 20 is worn, the back net 21 lies against the user's back, in particular at least partially and/or in the upper back region.

The exoskeleton 20 further comprises the support section 3 movably coupled to the base section 1 for supporting a body part, preferably a limb, in particular an arm 4, of the human body of the user. In particular, the support section 3 is designed to be attached to the body part, preferably the limb, in particular the arm 4, of the user. The support section 3 comprises, by way of example, an in particular rigid arm part 11 and an arm attachment 12 arranged on the arm part 11, which is designed, by way of example, as an arm shell. The arm part 11 is exemplarily elongated and, when worn, is aligned with its longitudinal axis in the direction of the longitudinal axis of the user's arm. As an example, the arm part 11 extends from the shoulder of the user to the elbow area of the user. The exoskeleton 20, in particular the arm part 11, ends at the elbow area of the user. The arm attachment 12 is used in particular to attach the support section 3 to the arm 4, in particular the upper arm, of the user. In particular, the arm shell surrounds the upper arm of the user, in particular at least partially, so that the upper arm can be held in the arm shell with a strap. The user's forearm is expediently not attached to the exoskeleton 20.

The body part is preferably a limb of the human body. For example, the body part is an arm of the human body. Furthermore, the body part may be the back of the human body. In this case, the base section expediently serves for attachment to a leg of the human body; i.e. the body section (to which the base section is to be attached) may be, for example, a leg in the case where the body part is the back.

As an example, the support section 3 is mounted so that it can pivot about a horizontal pivot axis relative to the base section 1, in particular relative to the back part 8. As an example, the support section 3 is mounted directly on a shoulder part 29. The horizontal pivot axis can also be referred to as the lifting axis 36. When the exoskeleton 20 is worn, the lifting axis 36 is located in the area of the user's shoulder. In particular, the exoskeleton 20 is designed to support the user's shoulder joint with the support section 3.

When the exoskeleton 20 is worn, the user can perform a lifting movement with his arm 4 supported by the support section 3 by pivoting the support section 3 about the lifting axis 36. In particular, the lifting axis 36 can be aligned in the y-direction. Expediently, the lifting axis 36 always lies in a horizontal plane, for example an x-y plane. In particular, a horizontal plane is to be understood as an exactly horizontal plane and/or a plane that is tilted by a maximum of 10 degrees, 7 degrees or 5 degrees relative to a horizon.

The pivot angle 47 of the support section 3 about the lifting axis 36 relative to the base section 1 should also be referred to as the lifting angle. The pivot angle 47 has a reference value, in particular a minimum value, when the support section 3 is oriented downwards (in the case of a vertically oriented exoskeleton 20) and increases continuously up to a maximum value when the support section 3 is pivoted upwards. The minimum value is in particular a minimum value in terms of amount, for example zero.

As an example, the pivot angle 47 is defined as an angle between a support section axis 61 and a base section axis 62. The support section axis 61 extends in the longitudinal direction of the support section 3. Exemplarily, the support section axis 61 extends from the lifting axis 36 in the direction of the arm attachment 12. In a state in which the user has put on the exoskeleton 20, the support section axis 61 expediently extends parallel to an upper arm axis of the arm 4 supported by the support section 3. The base section axis 62 expediently represents a vertical axis of the base section 1 and extends vertically downwards, in particular in a vertical orientation of the base section 1, for example in a state in which the user has put on the exoskeleton 20 and is standing upright. As an example, the pivot angle 47 lies in a z-x plane, for example when the user is standing upright and the arms are raised forwards.

The exoskeleton 20 comprises, by way of example, a shoulder joint arrangement 9, via which the support section 3 is attached to the base section 1, in particular the back part 8. The shoulder joint arrangement 9 expediently comprises a joint chain with one or more pivot bearings for defining one or more vertical axes of rotation. By means of the joint chain, it is expediently possible to pivot the support section 3 relative to the base section 1, in particular relative to the back part 8, in a preferably horizontal pivot plane, for example about a virtual vertical axis of rotation. In particular, the joint chain enables the user to pivot his arm 4, which is supported by the support section 3, about a vertical axis of rotation running through the user's shoulder, whereby the support section 3 is moved along with the arm 4. As an example, the joint chain is designed to be passive, so that the exoskeleton 20 does not provide any active support force in the direction of the horizontal pivot movement when the arm is pivoted in the preferably horizontal pivot plane.

The shoulder joint arrangement 9 is expediently arranged and/or designed in such a way that it defines a free space which, when the exoskeleton 20 is worn, is located above the shoulder of the user wearing the exoskeleton 20, so that the user can align his arm, which is supported by the support section 3, vertically upwards through the free space past the shoulder joint arrangement 9.

By way of example, the shoulder joint arrangement 9 comprises an inner shoulder joint section 27, which is mounted so as to be pivotable about a first vertical axis of rotation relative to the base section 1, in particular to the back part 8, by means of a first pivot bearing of the shoulder joint arrangement 9. By way of example, the shoulder joint arrangement 9 further comprises an outer shoulder joint section 28, which is mounted so as to be pivotable about a second vertical axis of rotation relative to the inner shoulder joint section 27 by means of a second pivot bearing of the shoulder joint arrangement 9. By way of example, the shoulder joint arrangement 9 further comprises a shoulder part 29 which is mounted so as to be pivotable about a third vertical axis of rotation relative to the outer shoulder joint section 28 by means of a third pivot bearing of the shoulder joint arrangement 9. Preferably, the inner shoulder joint section 27, the outer shoulder joint section 28 and the shoulder part 29 in the shoulder joint arrangement 9 are kinematically coupled to one another as the joint chain in such a way that the pivot angle of the inner shoulder joint section 27 relative to the base section 1 determines the pivot angle of the outer shoulder joint section 28 relative to the inner shoulder joint section 27 and/or the pivot angle of the shoulder part 29 relative to the outer shoulder joint section 28.

FIG. 3 shows a schematic detailed view of the support section 3, with components arranged within the arm part visibly shown. The arm part 11 expediently comprises an arm part housing, which is in particular rigid and made of plastic, for example.

The exoskeleton 20 comprises an actuator device 5 acting on the support section 3 to provide a support force for the body part, preferably the limb, exemplarily for the user's arm. By way of example, the actuator device 5 is arranged at least partially in the arm part 11.

The actuator device 5 is an active actuator device. Expediently, the exoskeleton 20 provides the support force by means of the actuator device 5 with a force component acting upwards in the direction of the pivoting movement about the lifting axis 36, which pushes the user's arm 4 upwards in the direction of the pivoting movement.

Preferably, the actuator device 5 comprises an actuator unit with an actuator member 32. The actuator unit can apply an actuator force to the actuator member 32 in order to provide the support force. The actuator member 32 is coupled to an eccentric section 35 arranged eccentrically to the lifting axis 36. The eccentric section 35 is part of the shoulder part 29, for example. By coupling the actuator member 32 to the eccentric section 35, the actuator force provides a torque of the support section 3 about the lifting axis 36 relative to the base section 1 and/or the shoulder part 29. Due to this torque, the support section 3 presses against the body part, preferably the limb, in particular the arm 4, of the user, in particular upwards, and thus provides the support force acting on the body part, preferably the limb, in particular the arm 4, of the user.

As an example, the actuator device 5 has a coupling element 33, in particular designed as a push rod, via which the actuator member 32 is coupled to the eccentric section 35.

Preferably, the actuator device 5 is a pneumatic actuator device and the actuator unit is expediently designed as a pneumatic drive cylinder 31. The actuator member 32 is the piston rod of the drive cylinder 31.

Alternatively, the actuator device may not be designed as a pneumatic actuator device. For example, the actuator device can be designed as a hydraulic and/or electric actuator device and, expediently, comprise a hydraulic drive unit and/or an electric drive unit as the actuator unit.

The drive cylinder 31, the actuator member 32 and/or the coupling element 33 are preferably arranged in the arm part housing.

The exoskeleton 20 expediently comprises a lifting pivot bearing 34, which provides the lifting axis 36. As an example, the support section 3 is attached to the shoulder joint arrangement 9 via the lifting pivot bearing 34.

FIG. 4 shows a rear view of the exoskeleton 20, whereby the textile support system and the force transmission element 18 are not shown.

The exoskeleton 20 comprises, by way of example, one or more batteries 22, a compressor 23, a valve unit 24 and/or a compressed air tank 25, which are expediently part of the base section 1 and are arranged in particular in the back part housing.

By way of example, the rechargeable battery 22 is arranged at the bottom of the back part 8 and, in particular, is inserted into a rechargeable battery holder of the back part 8 from below. Expediently, the compressed air tank 25 is arranged in an upper region in the back part 8, exemplarily (in particular in the longitudinal direction of the back part 8 and/or vertical direction) above the valve unit 24, the control device 7, the compressor 23 and/or the rechargeable battery 22. The valve unit 24 and/or the control device 7 is (in particular in the longitudinal direction of the back part 8 and/or vertical direction) expediently arranged above the compressor and/or above the rechargeable battery 22. The compressor 23 is arranged (in particular in the longitudinal direction of the back part 8 and/or vertical direction) above the battery 22.

The battery 22 serves as an electrical power supply for the exoskeleton 20, in particular for the compressor 23, the valve unit 24, a sensor device 6 and/or a control device 7.

The compressor 23 is designed to compress air in order to generate compressed air. The compressed air tank 25 is designed to store compressed air—in particular the compressed air generated by the compressor 23.

The valve unit 24 expediently comprises one or more electrically operable valves and is designed in particular to influence a pneumatic connection from the compressed air tank 25 to a pressure chamber of the pneumatic drive cylinder 31, in particular to selectively establish and/or block the pneumatic connection. Expediently, the valve unit 24 is further designed to influence a pneumatic connection from the compressed air tank 25 to the environment of the exoskeleton 20 and/or a pneumatic connection from the pressure chamber of the drive cylinder 31 to the environment of the exoskeleton 20, in particular to selectively establish and/or block the pneumatic connection. The valve unit 24 is expediently part of the actuator device 5.

The exoskeleton 20 further comprises a sensor device 6. As an example, the sensor device 6 comprises an angle sensor 37 for detecting the angle of the support section 3 relative to the base section 1, in particular the arm part 11 relative to the shoulder part 29. This angle should also be referred to as the pivot angle 47 or the lifting angle. The angle sensor 37 is used in particular to detect the angle of the support section 3 about the lifting axis 36. The angle sensor 37 is designed, for example, as an incremental encoder and is arranged in particular on the lifting pivot bearing 34, in particular in the arm part 11 and/or in the shoulder part 29.

Preferably, the sensor device 6 further comprises at least one pressure sensor for detecting the pressure prevailing in the pressure chamber of the drive cylinder 31 and/or the pressure prevailing in the compressed air tank 25. The at least one pressure sensor is expediently arranged in the back part 8 and/or in the arm part 11.

The exoskeleton device 10, in particular the exoskeleton 20, expediently comprises a control device 7, which for example comprises a microcontroller or is designed as a microcontroller. The control device 7 is used in particular to control the actuator device 5, in particular the valve unit 24, in order to control the provision of the support force.

Furthermore, the control device 7 is used to read out the sensor device 6, in particular to read out data recorded by the sensor device 6 and/or to communicate with the tool 30 and/or the mobile device 40. Preferably, the control device 7 is designed to adjust the pressure prevailing in the pressure chamber of the drive cylinder 31 by actuating the valve unit 24, in particular to closed-loop control the pressure, for example taking into account a pressure value recorded by means of the pressure sensor. In particular, the control device 7 is designed to increase the pressure prevailing in the pressure chamber by actuating the valve unit 24 in order to increase the support force and/or to reduce the pressure prevailing in the pressure chamber by actuating the valve unit 24 in order to reduce the support force.

According to a preferred embodiment, the control device 7 is designed to adjust the support force on the basis of the pivot angle 47 of the support section 3 detected in particular by means of the angle sensor 37. Expediently, the user can use his muscle strength to change the pivot angle 47 of the support section 3 by pivoting his arm 4, thereby influencing in particular the provision of the support force. In particular, the support force is low enough so that the user can change the pivot angle 47 of the support section 3 by pivoting his arm 4 using his muscle strength. The support force is limited, for example, by the design of the pneumatic system, in particular the compressor, and/or by the control device 7.

The control device 7 is preferably part of the exoskeleton 20 and is exemplarily arranged in the base section 1, in particular in the back part 8. Optionally, the control device 7 can be at least partially implemented in the mobile device 40.

As an example, the exoskeleton 20 comprises an operating element 14, which is expediently attached to the base section 1 via an operating element cable 15. The user can control the exoskeleton 20 via the operating element 14 and, in particular, activate, deactivate and/or set the support force to one of several possible force values greater than zero.

As an example, the exoskeleton 20 further has a connecting element 26, via which the shoulder joint arrangement 9 is attached to the base section 1, in particular the back part 8. The connecting element 26 is exemplarily designed as a pull-out element. The connecting element 26 is expediently adjustable in its position relative to the base section 1, in particular relative to the back part 8, in order to be able to adapt the position of the shoulder joint arrangement 9 and the support section 3 to the shoulder width of the user. In particular, the position of the connecting element 26 can be adjusted by pushing or pulling the connecting element 26 in or out of the back part 8.

By way of example, the exoskeleton 20 has a first support section 3A, a first shoulder joint arrangement 9A and a first connecting element 26A, as well as a second support section 3B, a second shoulder joint arrangement 9B and a second connecting element 26B. The components whose reference signs are provided with the suffix “A” or “B” are expediently each designed in correspondence with the components provided with the same reference sign number but without the suffix “A” or “B”, for example identical or mirror-symmetrical, so that the explanations in this regard apply in correspondence.

The first support section 3A, the first shoulder joint arrangement 9A and the first connecting element 26A are arranged on a first, exemplarily the right, side (in width direction) of the base section 1, and serve to support a first, in particular the right, arm of the user.

The second support section 3B, the second shoulder joint arrangement 9B and the second connecting element 26B are arranged on a second, exemplarily the left, side (in width direction) of the base section 1 and serve to support a second, in particular the left, arm of the user.

The first support section 3A comprises a first arm part 11A, a first arm attachment 12A and/or a first actuator unit, in particular a first drive cylinder.

The second support section 3A comprises a second arm part 11B, a second arm attachment 12B and/or a second actuator unit, in particular a second drive cylinder.

Preferably, the control device 7 is designed to set a first support force for the first support section 3A by means of the first actuator unit and to set a second support force for the second support section 3B by means of the second actuator unit, which second support force is expediently different from the first support force.

The first shoulder joint arrangement 9A comprises a first inner shoulder joint section 27A, a first outer shoulder joint section 28A and a first shoulder part 29A. The second shoulder joint arrangement 9B comprises a second inner shoulder joint section 27B, a second outer shoulder joint section 28B and a second shoulder part 29B.

The first support section 3A is pivotable about a first horizontal lifting axis 36A relative to the base section 1 and the second support section 3B is pivotable about a second horizontal lifting axis 36B relative to the base section 1.

In FIG. 2, the exoskeleton 20 is shown in a state in which it is worn by a user, in particular worn as intended. By the formulation that the user is wearing the exoskeleton 20, in particular wearing it as intended, it is meant that the user has put on the exoskeleton, i.e. put it on, by way of example in that the user is wearing the back part 8 on his back like a backpack, has put on the pelvic strap 16 around his hips, the shoulder strap or shoulder straps 19 run over the shoulder or shoulders of the user and/or one or both arms of the user are attached to the respective support section 3 with a respective arm attachment 12.

By way of example, the exoskeleton 20 is designed to support the user during a lifting movement of a respective arm, i.e. during an upwardly directed pivoting of the respective support section 3 about a respective lifting axis 36, with a respective support force acting in particular upwards. Furthermore, the exoskeleton 20 is expediently designed to support or counteract the user during a lowering movement, i.e. during a downward pivoting of the respective support section 3 about a respective lifting axis 36, with a respective support force acting in particular upwards, or to deactivate or reduce the respective support force during the lowering movement.

The exoskeleton device 10 comprises a light output device 171. The control device 7 is configured to control the light output device 171 in order to adjust an orientation 174 of a light beam 172 provided by the light output device 171 and/or a light intensity of the light output device 171 and/or to project auxiliary information 173 into an environment of the exoskeleton device 10.

The light output device 171 expediently comprises one or more light output units 184 to provide the light beam 172. The light beam 172 is, for example, a light cone and/or a light ray. Each light output unit 184 is designed, for example, as a headlight or comprises a headlight. In particular, each light output unit 184 comprises a respective light source.

The orientation 174 of the light beam 172 is expediently the direction, in particular the main direction, in which the light beam 172 propagates, in particular propagates most strongly, starting from the light output device 171, in particular the light output unit 184. The orientation 174 is, for example, a three-dimensional orientation vector of the light beam 172.

Preferably, the light output device 171 is part of the exoskeleton 20 and/or in particular arranged on the exoskeleton 20.

By way of example, the light output device 171, in particular a light output unit 184, is arranged on the base section 1, in particular on the back part 8, as shown by way of example in FIG. 1.

FIG. 7 shows further possible locations at which the light output device 171, in particular a respective light output unit 184, can be arranged. For example, the light output device 171, in particular a light output unit 184, can be arranged on the support section 3, in particular on the arm part 11 and/or on the arm attachment 12. Furthermore, it is possible that the light output device 171, in particular a light output unit 184, is arranged on the textile carrying system, for example a shoulder strap 19 and/or the pelvic strap 16, and/or on the operating element 14.

Optionally, the light output device 171 comprises a plurality of light output units 184, in particular designed as headlights, which are arranged distributed on the exoskeleton 20, in particular at one or more of the aforementioned locations.

The following explanations relating to the light output device 171 and/or the light output unit 184 apply expediently to several or all light output units 184.

Preferably, the exoskeleton device 10 comprises an actuator 177 for moving the light output unit 184. For adjusting the orientation 174 of the light beam 172, the control device 7 is configured to control the actuator 177 to effect a movement of the light output unit 184. The actuator 177 comprises, for example, an electric motor with which the light output unit 184 can be moved in order to change the orientation of the light output unit 184. In particular, the light output unit 184 can be caused to rotate by the actuator 177, in particular about a vertical axis and/or a horizontal axis.

The actuator 177 is configured to change the orientation of the light output unit 184, in particular relative to the base section 1 and/or support section 3, and thereby change the orientation 174 of the light beam 172, in particular relative to the exoskeleton 20. For example, the actuator 177 is configured to change the orientation of the light output unit 184 relative to the back part, the textile support system, in particular the shoulder strap 19 and/or the pelvic strap 16, and/or the operating element 14, and/or the arm part 11 and/or the arm attachment 12, in order to change the orientation 174 of the light beam 172, in particular relative to the exoskeleton 20.

Optionally, several actuators 177 are provided, in particular a respective actuator 177 is provided for several or all light output units 184. For example, a respective actuator 177 is provided on the base section 1, the support section 3, the back part 8, the textile carrying system, the shoulder strap 19, the pelvic strap 16, the operating element 14, the arm part 11 and/or the arm attachment 12 in order to adjust the orientation of a respective light output unit.

The one or more actuators 177 are expediently present in addition to the actuator device 5, in particular in addition to the actuator units, which serve to provide the support force. In particular, the actuators 177 can be controlled and/or actuated separately from the actuator device 5, in particular separately from the actuator units.

The exoskeleton device 10, in particular the exoskeleton 20, comprises the rechargeable battery 22 for operating the exoskeleton device 10. Preferably, the light output device 171, in particular each light output unit 184 and/or each actuator 177, is electrically powered from the rechargeable battery 22.

Expediently, the control device 7 is configured to adjust the orientation 174 of the light beam 172 in order to achieve selective illumination of a predetermined work area, and preferably not to illuminate areas which do not belong to the work area. Expediently, the control device 7 is configured to receive and/or generate work area information indicating a work area to be illuminated, and to selectively illuminate the work area in accordance with the work area information by controlling the light output device 171. The work area is, for example, an action area in which an action is performed with the exoskeleton 20.

Preferably, the control device 7 is configured to adjust the orientation 174 of the light beam 172 according to a position of the support section 3. In particular, the control device 7 is configured to automatically adjust the orientation 174 of the light beam 172 in accordance with an orientation of the arm 4 of the user, in particular by detecting the position of the support section 3 and adjusting the orientation 174 of the light beam 172 based on the detected position, preferably in such a way that the light beam 172 follows the orientation of the arm 4.

The exoskeleton device 10 comprises the angle sensor 37 for detecting an angle, in particular the pivot angle 47, of the support section 3. The control device 7 is expediently configured to detect the angle, in particular the pivot angle 47, of the support section 3 by means of the angle sensor 37. Preferably, the control device 7 is configured to adjust the orientation 174 of the light beam 172, the light intensity and/or the projection of the auxiliary information 173 in accordance with the detected angle, in particular the pivot angle 47. In particular, the control device 7 adjusts the orientation 174 in such a way that the light beam 172 follows a movement of the support section 3. The light beam 172 is expediently provided by a light output unit 184, which is not arranged on the support section 3.

Preferably, the control device 7 controls the orientation 174 of the light beam 172 using the sensor system of the exoskeleton, for example using the angle sensor 37, which is designed in particular as a rotation angle sensor, in particular in such a way that the light beam 172 achieves illumination in accordance with a working height of the user's arm 4.

Selective illumination of the work area can be achieved, as explained above, in particular by corresponding orientation of the light output unit 184 by means of the actuator 177. Alternatively or additionally, selective illumination of the work area can be achieved by selectively controlling various sectors of a light source, for example an LED panel, of the light output device 171.

For example, the light output device 171 has several light output sections 176 that can be switched on and off independently of one another. The light output sections 176 are, for example, different sectors of an LED panel, such as a matrix LED panel. In particular, the light output sections 176 are different LED sectors of an LED panel. For example, the light output sections 176 are part of a light source or part of a light output unit 184 designed in particular as a spotlight. FIG. 5 shows a schematic light output unit 184 with several light output sections 176, which are arranged in an exemplary distributed manner, in particular horizontally and/or vertically distributed, exemplarily in a matrix. For the sake of clarity, not all light output sections 176 are provided with the reference sign 176 in FIG. 5. By way of example, the light output sections 176 are arranged in a common light output unit housing 185.

The control device 7 is configured to adjust the orientation 174 of the light beam 172 by selectively switching the light output sections 176 on and off, in particular according to the position of the support section 3, as explained above, for example. Expediently, the control device 7 switches on only a part of the light output sections 176, in particular in order to achieve an orientation 174 of the light beam 172 to the work area, and thereby a selective illumination of the work area. In particular, taking into account the position of the support section 3, the control device 7 switches on respective one or more light output sections 176 whose output light is directed onto a work area defined by the position of the support section 3, and/or switches off respective one or more light output sections 176 which are directed (in particular with their light that can be output) onto an area outside the work area.

Preferably, the control device 7 is configured to detect the position of the support section 3 with at least two different degrees of freedom, for example in two different spatial directions. The two degrees of freedom are also referred to as detection degrees of freedom. The degrees of freedom include translational and/or rotational degrees of freedom. A first degree of freedom is, for example, the pivot angle 47 of the support section 3. The second degree of freedom expediently relates to a horizontal pivot angle of a pivot of the support section 3 relative to the base section 1 in a horizontal pivot plane and/or about an in particular virtual vertical axis of rotation, which is expediently defined by the shoulder joint arrangement 9. Preferably, the sensor device 6 comprises a pivot angle sensor arranged in particular on the shoulder joint arrangement 9 for detecting the horizontal pivot angle.

Preferably, the control device 7 detects the height of the user's upper arm as the first degree of freedom (for example by means of the pivot angle 47) and detects an orientation of the user's upper arm to the side as the second degree of freedom (for example by means of the horizontal pivot angle).

The control device 7 is preferably configured to adjust the orientation 174 of the light beam 172 with at least two different degrees of freedom, in particular in at least two different spatial directions, in particular on the basis of the position detected with the two detection degrees of freedom. The two degrees of freedom for adjusting the orientation 174 shall also be referred to as orientation degrees of freedom and expediently comprise translational and/or rotational degrees of freedom. For example, the first orientation degree of freedom is the vertical component of the orientation 174 of the light beam and the second orientation degree of freedom is the horizontal component of the orientation 174 of the light beam.

For example, the actuator 177 has two degrees of freedom, such as two different axes of rotation, to move the light output unit 184 according to the two degrees of freedom and thereby adjust the orientation 174 according to the two degrees of orientation freedom.

Optionally, the control device 7 performs selective switching on and off of light output sections 176 arranged distributed in two spatial directions, for example horizontally and vertically, to adjust the orientation 174 according to the two degrees of freedom of orientation.

Preferably, the exoskeleton device 10, in particular the exoskeleton 20, comprises an optical sensor 175 for detecting optical sensor data. As an example, the optical sensor 175 is arranged at the light output unit 184. Alternatively, the optical sensor 175 may be arranged at a different location. Preferably, the optical sensor 175 is an image sensor and/or a brightness sensor. The optical sensor data is preferably image sensor data and/or brightness sensor data.

The control device 7 is configured to adjust the orientation 174 of the light beam 172, the light intensity of the light output device 171 and/or the projection of the auxiliary information 173 on the basis of the optical sensor data.

In particular, the control device 7 is configured to perform, on the basis of the image sensor data, image recognition of a recognition object in the image sensor data and to adjust the orientation 174 of the light beam 172 on the basis of the image recognition of the recognition object, in particular in such a way that the recognition object is selectively illuminated or selectively not illuminated by the light beam 172. The recognition object is, for example, a body part, preferably a limb, of the user, for example one or both hands of the user, a tool, a bystander and/or a work area. In particular, the exoskeleton device 10 can therefore control the illumination and/or the light cone of the light output device 171 via optical recognition of the user's hands. The image sensor is, for example, a camera and is optionally integrated in a light output unit 184, in particular in a light source.

Preferably, the control device 7 adapts the light intensity of the light emitted by the light output device 171, in particular the light beam 172, to an ambient condition. The ambient condition is, for example, the brightness of the environment of the exoskeleton 20. By means of the optical sensor 175 designed as a camera or as a brightness sensor, in particular a light sensor, the exoskeleton 20 detects the brightness, in particular the illumination intensity, of the work environment and adjusts the light intensity of the light output device 171, in particular of one or more light sources of the light output device 171, in accordance with the detected brightness. In particular, the exoskeleton 20 adjusts the light intensity of the light emitted by the light output device 171, for example the light beam 172, in such a way that a lower light intensity is set in brighter environments than in darker environments or that a light output of the light output device 171 is switched off at a predetermined brightness. In particular, the light intensity is set, the light output is switched off and/or the orientation 174 of the light beam 172 is set in such a way that energy is saved and/or glare to the user and/or bystanders is avoided.

Preferably, the control device 7 is configured to adjust the orientation 174 of the light beam 172, the light intensity and/or the projection of the auxiliary information 173 on the basis of position information that indicates a position of the exoskeleton 20 and/or the user, in particular relative to the environment, and/or a position of an object separate from the exoskeleton 20, for example the tool 30. In particular, the object is a signal emitting object. For example, the exoskeleton 20 receives the position information and/or generates the position information, for example using a GPS receiver and/or on the basis of a signal emitted by the object, in particular the tool 30, for example a coupling signal and/or Bluetooth signal. In particular, the control device 7 adjusts the orientation 174 of the light beam 172 on the basis of the position information so that the light beam 172 is directed towards the object whose position is indicated by the position information. For example, the exoskeleton 20 directs the light beam of the light output device 171 onto a hand tool, for example the tool 30, which is held by the user and optionally coupled to the exoskeleton 20, in particular an electric hand tool, preferably on the basis of a bearing of a Bluetooth signal of the tool 30 taken by the exoskeleton 20.

Optionally, the exoskeleton device 10 is further configured to use the light output device 171, in particular a light source of the light output device 171, for example the light output unit 184, as a warning and/or signal light, for example to output a warning signal.

For example, the exoskeleton device 10 is configured to illuminate a walking path, for example in a warehouse, with the light output device 171, for example on the basis of received and/or generated walking path information. In particular, the exoskeleton device is configured to emit light while the user is moving along the walking path in order to 10 make the position and/or movement of the user more visible and to reduce the risk of a collision, in particular at an intersection.

Preferably, the exoskeleton device 10 comprises an image sensor. For example, the optical sensor 175 is designed as an image sensor. The control device 7 is configured to set an orientation of the image sensor and the orientation 174 of the light beam 172 corresponding to each other, in order to use the image sensor to capture image sensor data from an illumination area 179 illuminated by the light output device 171. For example, the exoskeleton device 10 comprises an image sensor actuator for adjusting the orientation of the image sensor relative to the exoskeleton 20, in particular relative to the base section 1 and/or the support section 3, to capture image data from a predetermined surrounding area of the exoskeleton 20. Expediently, the control device 7 controls the image sensor actuator corresponding to the control of the actuator 177, so that the image sensor actuator orients the image sensor to the illumination area 179 illuminated by the light output device 171. As an example, the image sensor is attached to the light output unit 184 and is expediently aligned together with the light output unit 184 by the actuator 177, in particular such that the image sensor picks up image data from the illumination area 179 illuminated by the light output unit 184.

In particular, a light source of the light output device 171 is coupled to a camera. For example, the camera is integrated in the light source and/or is synchronized with the orientation of the light source. In particular, the control device 7 is designed to record documentation image data with the image sensor, in particular the camera, and store it in a non-volatile memory and/or transfer it to a non-volatile memory (for example in the cloud). For example, the exoskeleton device can document a “point of interest” determined by the orientation of the arm 4 and illuminated by the light source, in particular the light output unit 184, by means of photos or videos using the camera, in particular for documentation of work performed and/or quality control.

Preferably, the control device 7 has at least two manually and/or automatically selectable presets, each of which has at least one light output characteristic that determines the light beam orientation 174 and/or light intensity of the light output device 171 as a function of at least one input variable, in particular a position, for example the pivot angle 47, of the support section 3. The at least two presets differ in their light output characteristics. Using a preset selected from the at least two presets, the control device 7 is configured to set the light beam orientation 174 and/or the light intensity as a function of the input variable.

The presets can also be referred to as application profiles. The presets are preferably stored in the control device 7.

Each light output characteristic represents a mapping of the at least one input variable to the light beam orientation 174 and/or the light intensity. For example, each light output characteristic comprises a characteristic curve that relates the light beam orientation 174 and/or the light intensity to the at least one input variable. For example, each light output characteristic defines a respective value of the light beam orientation 174 and/or the light intensity for each value of the value range of the input variable. In particular, the characteristic varies over the value range of the input variable. The characteristic can also be referred to as a light output characteristic. The light output characteristic can, for example, be part of a light output map.

Preferably, the presets also each have at least one support force characteristic, which defines a support force specification as a function of at least one input variable, in particular a position, for example the pivot angle 47, of the support section. The at least two presets differ in their support force characteristics. Using a preset selected from the at least two presets, the control device 7 is configured to determine a support force specification as a function of the input variable and to set the support force on the basis of the support force specification.

Each support force characteristic represents a mapping of the at least one input variable to the support force specification. For example, each support force characteristic comprises a characteristic curve that sets the support force specification as a function of the at least one input variable. For example, each support force characteristic defines a respective value of the support force specification for each value of the value range of the input variable. In particular, the characteristic curve varies over the value range of the input variable. The characteristic curve can also be referred to as the support force characteristic curve. The support force characteristic curve can, for example, be part of a support force map.

The support force specification expediently corresponds to the actuator force to be provided and/or the support force to be provided and is preferably identical to or proportional to the actuator force to be provided and/or the support force to be provided. For example, the support force specification corresponds to a pressure to be provided in the pressure chamber of the pneumatic drive cylinder 31. In particular, the support force specification is identical to or proportional to the pressure to be provided in the pressure chamber.

In particular, in the control device 7 presets in accordance with one or more of the above explained procedures for setting the light beam orientation 174 and/or the light intensity and/or projection of the auxiliary information 173 are stored. The user can select a corresponding preset according to his task area or the work to be performed.

Preferably, in one or more presets, a light output characteristic is linked to a support force characteristic. For example, a preset can be configured by a user, in particular via the mobile device 40 and/or the operating element 14. For example, a user can configure a preset by selecting, for example from a characteristic library, a support force characteristic and a light output characteristic.

Preferably, the preset to be used can be selected manually, for example via the operating element 14 and/or the mobile device 40.

Preferably, the control device 7 is configured to select the preset to be used on the basis of one or more triggers, in particular to activate it automatically.

The trigger is, for example, the receipt or occurrence of location information, tool information, person information and/or movement information. Optionally, the preset to be used can be selected in response to a combination of triggers.

In particular, the location information indicates a geographical location. For example, the control device 7 receives a GPS signal and calculates the location information on the basis of the GPS signal. Furthermore, the control device 7 can receive the location information from a workstation, for example a station on a production line, by means of a location signal transmitted at the workstation, in particular by the station. Based on the location information, the control device 7 selects a preset that matches the location indicated by the location information.

The tool information indicates a tool, for example tool 30. For example, the control device 7 receives the tool information from the tool 30 by means of a tool signal, for example in the case of a Bluetooth connection between the exoskeleton 20 and the tool 30. The control device 7 selects a preset that matches the tool displayed by the tool information on the basis of the tool information.

The personal information indicates a person. For example, the control device 7 receives the personal information by means of a personal signal sent in particular by the mobile device 40, for example a smartphone. Furthermore, the exoskeleton 20 can comprise an identification device, for example a finger print sensor and/or an image sensor, in order to determine the personal information. Based on the personal information, the control device 7 selects a preset that matches the person indicated by the personal information.

The movement information indicates a movement, in particular a movement pattern, of the exoskeleton 20, in particular of the support section 3, and/or of the tool 30. Optionally, the movement information indicates that a movement of the exoskeleton 20, in particular of the support section 3, correlates, in particular matches, a movement of the tool 30. For example, the control device 7 receives a tool movement signal from the tool 30 and determines the movement information on the basis of a movement of the exoskeleton 20 detected in particular by the sensor device 6 and the tool movement signal. Based on the movement information, the control device 7 selects a preset that matches the movement indicated by the movement information.

Optionally, the control device 7 is designed to select the preset to be used from the available presets on the basis of the location information, the tool information, the person information and/or the movement information, in particular automatically.

In the following, it will be discussed in more detail how a light source of the light output device 171 located on the exoskeleton 20 can be used to provide user guidance functions, for example by using the light source to communicate information to the user, preferably by projecting the auxiliary information 173 into the environment of the exoskeleton device 10.

Optionally, the exoskeleton device 10 provides an augmented reality function, for example by means of the light output device 171, in particular by means of a light output unit 184. The augmented reality function serves in particular to provide the user with information, for example on one or more objects illuminated by the light output device 171.

For example, the auxiliary information 173 comprises an orientation indicator, in particular a spirit level, and/or an auxiliary line 181 or several auxiliary lines, in particular a grid 182 of auxiliary lines. FIG. 6 shows examples of the auxiliary information 173. For example, the auxiliary line 181 is a horizontal auxiliary line. Furthermore, the auxiliary line 181 can be a vertical auxiliary line. Furthermore, the grid 182 can comprise a plurality of horizontal auxiliary lines, in particular running parallel to one another, and/or a plurality of vertical auxiliary lines, in particular running parallel to one another.

Optionally, the control device 7 is configured to set the auxiliary information 173 on the basis of the image sensor data captured by the image sensor, in particular on the basis of a recognition object recognized in the image sensor data.

Preferably, the control device 7 is configured to select an action area 183B from a plurality of possible action areas 183A, 183B, 183C of the environment of the exoskeleton device 10 and to adjust the orientation 174 of the light beam 172 such that the selected action area 183B is selectively illuminated by the light output device 171, in particular to indicate the selected action area 183B. The action areas can also be referred to as work areas. In particular, the control device 7 adjusts the light beam orientation 174 such that the selected action area 183B is illuminated more strongly by the light output device 171 than the non-selected action areas 183A, 183C, in particular such that the selected action area 183B is illuminated by the light output device 171 and the non-selected action areas 183A, 183C are not illuminated by the light output device 171. In particular, the exoskeleton 20 illuminates the selected action area 183B to thereby draw the user's attention to the selected action area 183B, for example to signal to the user that the user should next take action in the selected action area 183B.

Expediently, the control device 7 is configured to generate and/or receive action area information indicating the selected action area 183B and/or the non-selected action areas 183A, 183C. For example, the control device 7 receives the action area information from a workstation in the environment of the exoskeleton device 10. Further, the control device 7 may be configured to generate the action area information based on image sensor data from the image sensor.

Optionally, the action area information displays an action area sequence of action areas and the control device 7 is configured to illuminate the action areas sequentially in accordance with the action area sequence, in particular to signal to the user the order in which he should take action in the action areas.

In particular, the exoskeleton device 10 is designed to specifically illuminate one or more action areas of the environment by means of a light source of the light output device 171 in order to emphasize the one or more action areas.

For example, the action areas may be storage areas, such as compartments and/or boxes, particularly in a warehouse. Furthermore, the action areas can be objects to be handled, for example boxes, for example on a shelf, in particular in a warehouse. Conveniently, the exoskeleton device 10 can provide a “pick-by-light” function by means of the light output device 171, in particular for picking goods in a warehouse. For example, the exoskeleton device 10 is designed to inform an order picker, for example the user, by means of light from the light output device 171, which compartment is to be opened next and/or which box and/or which object is to be lifted from a shelf.

Furthermore, the action areas may be parts of a workpiece to be machined. The exoskeleton device 10 is expediently designed, for example in the case of an in particular industrial multi-step, optionally recurring, production sequence, to inform the user of a sequence of work steps by means of the light emitted by the light output device 171, for example by highlighting the part of the workpiece on which the next work step is to be carried out by means of the emitted light after completion of a work step.

Furthermore, the exoskeleton device 10 can be configured to adopt a training mode and, in the training mode, to communicate a sequence of work steps to a user by means of the light emitted by the light output device 171, in particular by sequentially illuminating action areas in the environment of the exoskeleton device 10.

As an example, the exoskeleton device 10 is designed to display, via the light emitted by the light output device 171, process parameters and/or graphical displays and/or instructions on parameters of a current work step, in particular to project the auxiliary information into the environment. For example, the auxiliary information comprises a progress indicator, an indicator of a force to be applied and/or a torque to be set on a cordless screwdriver.

Optionally, the exoskeleton device 10 is designed to indicate, via the light emitted by the light output device 171, a position and/or a next work step in a collaboration with a robot, in particular a cobot, in particular to project it as the auxiliary information into the environment, in particular in a constellation in which the user cannot see the robot, for example when the user and the robot are on different sides of a wall, for example an aircraft hull. For example, the user is on the inside of the aircraft hull and the robot is on the outside of the aircraft hull. Expediently, the exoskeleton device 10 communicates with the robot, in particular wirelessly.

Optionally, the light output device 171 can comprise different types of light sources, in particular as a respective light output unit 184, for example a polychromatic light source, in particular for illuminating the work area, and/or as a visual guide during order picking and/or a monochromatic and/or less fanned-out light source, for example to project the auxiliary information into the environment, in particular auxiliary lines onto a surface.

Optionally, the exoskeleton device 10 may comprise an augmented reality system comprising, for example, augmented reality goggles and/or an augmented reality visor.

For example, the exoskeleton device 10 can display information, in particular instructions, by means of the augmented reality system, in particular in addition to and/or corresponding to information projected into the environment by the light output device 171.

Optionally, the exoskeleton device 10 can be designed to visualize information on movement/ergonomics by means of the light output device 10.

1. An exoskeleton device, comprising:
an exoskeleton having:
a base section for attachment to a body section of the human body,
a support section for supporting a body part of the human body, wherein the support section is movably coupled to the base section,
an actuator device for providing a support force for the body part, wherein the actuator device is acting on the support section, wherein the exoskeleton device further comprises:
a light output device and
a control device which is configured to control the light output device in order to set an orientation of a light beam provided by the light output device and/or a light intensity of the light output device and/or to project auxiliary information into an environment of the exoskeleton device.

2. The exoskeleton device according to claim 1, wherein the control device is configured to adjust the orientation of the light beam according to a position of the support section.

3. The exoskeleton device according to claim 2, further comprising an angle sensor for detecting an angle of the support section, wherein the control device is configured to adjust the orientation of the light beam, the light intensity and/or the projection of the auxiliary information according to the detected angle.

4. The exoskeleton device according to claim 2, wherein the control device is configured to detect the position of the support section with at least two different degrees of freedom and/or to adjust the orientation of the light beam with at least two different degrees of freedom.

5. The exoskeleton device according to a preceding claim 1, further comprising an optical sensor for detecting optical sensor data, wherein the control device is configured to adjust the orientation of the light beam, the light intensity and/or the projection of the auxiliary information on the basis of the optical sensor data.

6. The exoskeleton device according to claim 1, wherein the control device is configured to adjust the orientation of the light beam, the light intensity and/or the projection of the auxiliary information on the basis of position information which indicates a position of the exoskeleton and/or a user relative to the environment and/or a position of an object separate from the exoskeleton.

7. The exoskeleton device according to claim 1, wherein the light output device has a plurality of light output sections which can be switched on and off independently of one another, and the control device is configured to set the orientation of the light beam by selectively switching the light output sections on and off.

8. The exoskeleton device according to claims 1, further comprising an actuator for moving a light output unit of the light output device, wherein the control device is configured to, for adjusting the orientation of the light beam, control the actuator in order to effect a movement of the light output unit.

9. The exoskeleton device according to claim 1, further comprising an optical sensor, wherein the control device is configured to set an orientation of the optical sensor and the orientation of the light beam in correspondence to each other in order to detect, with the optical sensor, optical sensor data from an illumination area illuminated by the light output device.

10. The exoskeleton device according to claim 1, further comprising a rechargeable battery for operating the exoskeleton device, wherein the light output device is electrically powered from the rechargeable battery.

11. The exoskeleton device according to claim 1, wherein the base section comprises a back part, a shoulder strap and/or a pelvic strap and the light output device is arranged on the back part, the shoulder strap and/or the pelvic strap.

12. The exoskeleton device according to claim 1, wherein the light output device is arranged at the base section and/or the support section.

13. The exoskeleton device according to claim 1, wherein the auxiliary information comprises an orientation indicator and/or one or more auxiliary lines.

14. The exoskeleton device according to claim 1, wherein the control device is configured to select one of a plurality of possible action areas of the environment of the exoskeleton device and to adjust the orientation of the light beam such that the selected action area is selectively illuminated by the light output device.

15. The exoskeleton device according to claim 1, wherein the control device has at least two manually and/or automatically selectable presets, each of which has at least one light output characteristic which determines the light beam orientation and/or light intensity as a function of at least one input variable, wherein the at least two presets differ in their light output characteristic, and wherein the control device is configured to set the light beam orientation and/or the light intensity as a function of the input variable using a preset selected from the at least two presets.

16. The exoskeleton device according to claim 15, wherein the presets furthermore each have at least one support force characteristic which defines a support force specification as a function of at least one input variable, wherein the at least two presets differ in their support force characteristic, and wherein the control device is configured to determine a support force specification as a function of the input variable using a preset selected from the at least two presets and to set the support force on the basis of the support force specification.

17. A method of operating an exoskeleton device according to claim 1, comprising the step of:
adjusting the orientation of the light beam and/or the light intensity and/or projecting the auxiliary information into the environment of the exoskeleton device.

18. The exoskeleton device according to claim 1, wherein the base section is configured for attachment to the torso of a human body and/or the support section is configured for supporting a limb of the human body.

19. The exoskeleton device according to claim 1, wherein the support section is configured for supporting an arm of the human body.

20. The exoskeleton device according to claim 1, wherein the actuator device is a pneumatic actuator device.

21. The exoskeleton device according to claim 15, wherein the input variable is a position of the support section.
